(19) United States
(12) Patent Application Publication
(10) Pub. No.: US 2013/0296388 A1
(43) Pub. Date: Nov. 7, 2013

(54) PHENOL-CONTAINING AZOLE COMPOSITIONS FOR THE PROTECTION OF INDUSTRIAL MATERIALS

(71) Applicant: LANXESS Deutschland GmbH, Leverkusen (DE)

(72) Inventors: Bernd KOOP, Cologne (DE); Martin KUGLER, Leichlingen (DE)

(21) Appl. No.: 13/934,349

(22) Filed: Jul. 3, 2013

Related U.S. Application Data
(62) Division of application No. 12/878,142, filed on Sep. 9, 2010.

(30) Foreign Application Priority Data
Sep. 14, 2009 (EP) 09170217.5

(51) Int. Cl. A01N 43/653; A01N 31/08

(52) U.S. Cl. CPC A01N 43/653; A01N 31/08
USPC 514/383

(57) ABSTRACT

A process for the protection of industrial materials in which a composition, comprising at least one azole and at least one phenol, is employed so as to treat the industrial material.

This application is a divisional of U.S. patent application Ser. No. 12/878,142 filed Sep. 9, 2010 with the same title, which claims the right of priority European Patent Application No. 09170217.5 filed Sep. 14, 2009, the contents of which are hereby incorporated by reference in their entirety.

The invention relates to compositions comprising at least one substituted phenol (I) and at least one azole, to the use of these compositions for the protection of industrial materials and to industrial materials.

Active compounds for the protection of materials, in particular against fungi, originate from a large number of compound classes. Of particular importance for the protection of wood are, for example, azoles, in particular triazoles. However, individual active compounds do not cover the whole spectrum of harmful fungi, so that frequently combinations of active compounds have to be applied, or the active compounds have to be used at appropriately high dosages.

To overcome these weaknesses of the active compounds, various alternatives of enhancing the activity have already been examined for the protection of materials, in particular for the protection of wood.

WO0071314 describes the use of amine oxides for enhancing the activity of azoles for the protection of wood. However, the fact that the amine oxides are water soluble results in the amine oxides being easily leached with water from the treated wood, the enhanced activity thus being lost again.

WO03065807 describes the use of alkoxylated amines for enhancing the activity of triazoles. However, the solubility of these activity enhancers in water likewise leads to them being easily leached with water from the treated wood.

U.S. Pat. No. 6,231,651-B1 describes the use of sterically hindered phenols for enhancing the activity of in particular propiconazole and tebuconazole for the protection of wood. However, the antioxidants used for this purpose, such as BHT, are employed in a very high excess of up to about 450:1 (mass ratio based on the azole). This is a great disadvantage both from an economical and from an ecological point of view.

In addition, the use of phenolic antioxidants as activity enhancers for tebuconazole and propiconazole in combination with complex formers, for example ethylenediaminetetraacetic acid (EDTA), is also known (Phytochemistry 2002, 61, 555-560). However, in this case, too, very high retentions of BHT of up to about 26 kg per m³ of wood are used.

It was an object of the present invention to provide activity enhancers for azoles for the protection of industrial materials, in particular for the protection of wood, against attack and/or destruction by microorganisms, which activity enhancers are, firstly, leached only in small amounts from the industrial material, and which can, secondly, be employed in an economical ratio to the azole.

Accordingly, we have, surprisingly, found a composition, comprising

a) at least one azole and

b) at least one phenol of the formula (I) or a salt thereof

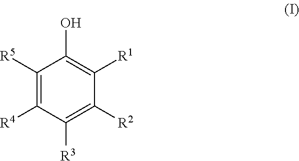

in which R¹, R², R³, R⁴ and R⁵ each independently of one another represent hydrogen, optionally substituted C₁-C₂₀-alkyl, C₂-C₂₀-alkenyl, C₇-C₁₈-alkylaryl or C₃-C₂₀-cycloalkyl, with the proviso that at least one of the radicals R¹-R⁵ is not hydrogen and with the proviso that, if the radicals R¹-R⁵ exclusively represent optionally substituted C₁-C₂₀-alkyl or optionally hydrogen
at least one of the radicals R¹-R⁵ represents a C₁-C₂-alkyl radical substituted by a phenyl radical, where the phenyl radical is optionally substituted by hydroxyl and/or C₁-C₄-alkyl and
the compound of the formula (I) carries at least one methyl group.

The azole used is preferably a fungicidally active azole, in particular at least one triazole or at least one imidazole. Particular preference is given to a triazole. In this respect, the composition for use in accordance with the invention is preferably employed as a microbicidal composition, in particular as a fungicidal composition.

Particularly preferred azoles are triazoles selected from the group consisting of azaconazole, bitertanol, bromuconazole, cyproconazole, diclobutrazol, difenoconazole, diniconazole, epoxyconazole, etaconazole, fenbuconazole, fluquinconazole, flusilazole, flutriafol, furconazole, hexaconazole, imibenconazole, ipconazole, myclobutanil, metconazole, penconazole, propiconazole, prothioconazole, simeconazole, tebuconazole, tetraconazole, triadimefon, triadimenol, triticonazole and uniconazole and their metal salts and acid adducts.

Preference is also given to compositions, comprising
a1) at least one azole selected from the group consisting of azaconazole, bitertanol, bromuconazole, cyproconazole, diclobutrazol, difenoconazole, diniconazole, epoxyconazole, etaconazole, fenbuconazole, fluquinconazole, flusilazole, flutriafol, furconazole, hexaconazole, imibenconazole, ipconazole, myclobutanil, metconazole, penconazole, propiconazole, prothioconazole, simeconazole, tebuconazole, tetraconazole, triticonazole and uniconazole and their metal salts and acid adducts and
a2) at least one azole selected from the group consisting of triadimenol and triadimefon.

Preference is given to using, in accordance with the invention, a composition comprising at least one azole selected from the group consisting of tebuconazole, propiconazole, triadimefon, triadimenol and cyproconazole.

Particular preference is given to compositions comprising at least one azole selected from the group consisting of tebuconazole, propiconazole and cyproconazole and optionally a further azole selected from the group consisting of triadimenol and triadimefon.

Particular preference is given here to the following azole combinations: tebuconazole and triadimefon, tebuconazole and propiconazole, tebuconazole and cyproconazole and also propiconazole and cyproconazole.

Particularly preferred imidazoles are, for example, clotrimazole, bifonazole, climbazole, econazole, fenapanil, imazalil, isoconazole, ketoconazole, lombazole, miconazole, pefurazoate, prochloraz, triflumizole and their metal salts and acid adducts.

Preferred are phenols of component b) in which at least one of the radicals R¹-R⁵ of the formula (I) represents

—CHR⁶-phenyl in which

R⁶ represents hydrogen or methyl and

phenyl is unsubstituted or substituted by hydroxyl and at least one C₁-C₄-alkyl radical.

Particular preference is given to compositions comprising, as component b), at least one styrenated phenol or 6,6′-di-tert-butyl-2,2′-methylenedi-p-cresol.

The styrenated phenol used may also be a mixture of one, two and/or three styrenated phenol, such as, for example, the product known as Vulkanox® SP from LANXESS which is a mixture of compounds of the formula (I) in which one to three of the radicals R¹-R⁵ of the formula (I) has/have the meaning —CH(CH₃)phenyl.

6,6′-Di-tert-butyl-2,2′-methylenedi-p-cresol is commercially available, for example, under the name Vulkanox® BKF from LANXESS.

The azole of component a) used is preferably employed in a weight ratio to b) of from 50:1 to 1:50, in particular of from 10:1 to 1:10, preferably of from 5:1 to 1:5. With particular preference, b) is employed in a ratio to the azole of from 1:1 to 5:1.

The compositions used in accordance with the invention can be employed in solid or liquid form. Suitable for this purpose are formulations such as solutions, emulsions, suspensions, powders, granules, pastes, aerosols and also very fine encapsulations in polymeric substances.

Such formulations can be produced in a known manner, for example by mixing the compositions with extenders, that is liquid solvents, liquefied gases under pressure, and/or solid carriers, optionally with the use of surfactants, that is emulsifiers and/or dispersants, and/or foam formers. If the extender used is water, it is also possible to employ organic solvents as auxiliary solvents. Essentially, suitable liquid solvents are: aromatics such as xylene, toluene or alkylnaphthalenes, chlorinated aromatics or chlorinated aliphatic hydrocarbons such as chlorobenzenes, chloroethylenes or methylene chloride, aliphatic hydrocarbons such as cyclohexane or paraffins, for example petroleum fractions, alcohols such as butanol or glycerol and their ethers and esters, ketones such as acetone, methyl ethyl ketone, methyl isobutyl ketone or cyclohexanone, strongly polar solvents such as dimethylformamide and dimethyl sulphoxide, or else water. Liquefied gaseous extenders or carriers are to be understood as meaning liquids which are gaseous at standard temperature and under atmospheric pressure, for example aerosol propellants such as halogenated hydrocarbons, or else butane, propane, nitrogen and carbon dioxide. Suitable solid carriers are: for example ground natural minerals such as kaolins, clays, talc, chalk, quartz, attapulgite, montmorillonite or diatomaceous earth, and ground synthetic minerals such as finely divided silica, alumina and silicates. Suitable solid carriers for granules are: for example crushed and fractionated natural rocks such as calcite, marble, pumice, sepiolite, dolomite, and synthetic granules of inorganic and organic materials, and also granules of organic material such as sawdust, coconut shells, maize cobs and tobacco stalks. Suitable emulsifiers and/or foam formers are: for example nonionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates, or else protein hydrolysates. Suitable dispersants are: for example lignosulphite waste liquors and methyl cellulose.

Tackifiers, such as carboxymethyl cellulose, natural and synthetic polymers in the form of powders, granules or latices, such as gum arabic, polyvinyl alcohol and polyvinyl acetate, and also natural phospholipids, such as cephalins and lecithins, and synthetic phospholipids can additionally be used in the formulations. Other possible additives are mineral and vegetable oils.

The composition used may preferably comprise chelators (for example ethylene-diaminetetraacetic acid (EDTA), diethylenetriaminepentaacetic acid (DTPA), nitrilotriacetic acid (NTA) or citric acid or salts thereof), preferably in a quantitative ratio to the azole of from 1:20 to 20:1, preferably from 5:1 to 1:5.

The compositions may furthermore comprise colorants such as inorganic pigments, for example iron oxide, titanium oxide, Prussian Blue, copper oxide and organic dyes, such as alizarine, azo and metallophthalocyanine dyes.

The composition used generally comprises preferably from 0.1 to 95 percent by weight of components a) and b), preferably from 0.5 to 90% by weight.

The compositions for use in accordance with the invention may also comprise further active compounds, for example fungicides, bactericides and/or insecticides, for example to broaden the activity spectrum or to prevent the development of resistance. In many cases, synergistic effects are obtained, i.e. the activity of combined active compounds is greater than the activity of the individual components.

Particularly favourable co-components in mixtures are, for example, the following compounds:

pyridines and pyrimidines such as:

ancymidol, buthiobate, fenarimol, mepanipyrin, nuarimol, pyroxyfur, triamirol;

succinate dehydrogenase inhibitors such as:

benodanil, bixafen, boscalid, carboxim, carboxim sulphoxide, cyclafluramid, fenfuram, flutanil, furametpyr, furcarbanil, furmecyclox, mebenil, mepronil, methfuroxam, metsulfovax, nicobifen, pyrocarbolid, oxycarboxin, Seedvax;

naphthalene derivatives such as:

terbinafine, naftifine, butenafine;

sulphenamides such as:

dichlofluanid, tolylfluanid, folpet, fluorofolpet, captan, captofol;

benzimidazoles such as:

carbendazim, benomyl, fuberidazole, thiabendazole or their salts;

morpholine derivatives such as:

aldimorph, dimethomorph, dodemorph, fall morph, fenpropidin fenpropimorph, tridemorph, trimorpharnid and their arylsulphonate salts such as, for example, p-toluenesulphonic acid and p-dodecylphenyl-sulphonic acid;

benzothiazoles such as:

2-mercaptobenzothiazole;

benzothiophene dioxides such as:

N-cyclohexyl-benzo[b]thiophene carboxamide S,S-dioxide;

benzamides such as:

2,6-dichloro-N-(4-trifluoromethylbenzyl)-benzamide, tecloftalam;

boron compounds such as:

boric acid, boric ester, borax;

formaldehyde and formaldehyde-releasing compounds such as:

benzyl alcohol mono-(poly)-hemiformal, n-butanol hemiformal, dazomet, ethylene glycol hemiformal, hexa-hydro-S-triazine, hexamethylenetetramine, N-hydroxymethyl-N′-methylthiourea, N-methyloIchloroacetamide, oxazolidine, paraformaldehyde, taurolin, tetrahydro-1,3-oxazine, N-(2-hydroxypropyl)-amine-methanol, tetramethylol acetylenediurea;

isothiazolinones such as:

N-methylisothiazolin-3-one, 5-chloro-N-methylisothiazolin-3-one, 4,5-dichloro-N-octylisothiazolin-3-one, 5-chloro-N-octylisothiazolinone, N-octyl-isothiazolin-3-one, 4,5-trimethylene-isothiazolinone, 4,5-benzoisothiazolinone;

aldehydes such as:

cinnamaldehyde, formaldehyde, glutardialdehyde, β-bromocinnamaldehyde, o-phthaldialdehyde; thiocyanates such as:

thiocyanatomethylthiobenzothiazole, methylenebisthiocyanate;

quaternary ammonium compounds and guanidines such as:

benzalkonium chloride, benzyldimethyltetradecylammonium chloride, benzyldimethyldodecylammonium chloride, dichlorobenzyldimethylalkylammonium chloride, didecyldimethylammonium chloride, dioctyldimethylammonium chloride, N-hexadecyltrimethylammonium chloride, 1-hexadecylpyridinium chloride, iminoctadine tris(albesilate);

iodine derivatives such as:

diiodomethyl p-tolyl sulphone, 3-iodo-2-propynyl alcohol, 4-chlorophenyl-3-iodo-propargylformal, 3-bromo-2,3-diiodo-2-propenyl ethylcarbamate, 2,3,3-triiodoallyl alcohol, 3-bromo-2,3-diiodo-2-propenyl alcohol, 3-iodo-2-propynyl n-butylcarbamate, 3-iodo-2-propynyl n-hexylcarbamate, 3-iodo-2-propynyl cyclohexylcarbamate, 3-iodo-2-propynyl phenylcarbamate;

phenols such as:

tribromophenol, tetrachlorophenol, 3-methyl-4-chlorophenol, 3,5-dimethyl-4-chlorophenol, dichlorphene, 2-benzyl-4-chlorophenol, triclosan, diclosan, hexachlorophene, p-hydroxybenzoic esters, o-phenylphenol, m-phenylphenol, p-phenylphenol, 4-(2-tert-butyl-4-methylphenoxy)-phenol, 4-(2-isopropyl-4-methylphenoxy)phenol, 4-(2,4-dimethylphenoxy)phenol and their alkali and alkaline earth metal salts;

microbicides with an activated halogen group such as:

bronopol, bronidox, 2-bromo-2-nitro-1,3-propanediol, 2-bromo-4′-hydroxy-acetophenone, 1-bromo-3-chloro-4,4,5,5-tetramethyl-2-imidazolidinone, B-bromo-B-nitrostyrene, chloracetamid, chloramin 1,3-dibromo-4,4,5,5-tetramethyl-2-imidazolidinone, dichloramin T, 3,4-dichloro-(3H)-1,2-dithiol-3-one, 2,2-dibromo-3-nitrile-propionamide, 1,2-dibromo-2,4-dicyanobutane, halane, halazone, mucochloric acid, phenyl (2-chlorocyano-vinyl) sulphone, phenyl (1,2-dichloro-2-cyanovinyl) sulphone, trichloroisocyanuric acid;

pyridines such as:

1-hydroxy-2-pyridinethione (and their Cu, Na, Fe, Mn, Zn salts), tetrachloro-4-methyl-sulphonylpyridine, pyrimethanol, mepanipyrim, dipyrithione, 1-hydroxy-4-methyl-6-(2,4,4-trimethylpentyl)-2(1H)-pyridine;

methoxyacrylates or similar such as:

azoxystrobin, dimoxystrobin, fluoxastrobin, kresoxim-methyl, metorninostrobin, orysastrobin, picoxystrobin, pyraclostrobin, trifloxystrobin;

metal soaps such as:

salts of the metals tin, copper and zinc with higher fatty acids, resin acids, naphthenic acids and phosphoric acid, such as, for example, tin naphthenate, tin octoate, tin 2-ethylhexanoate, tin oleate, tin phosphate, tin benzoate, copper naphthenate, copper octoate, copper 2-ethylhexanoate, copper oleate, copper phosphate, copper benzoate, zinc naphthenate, zinc octoate, zinc 2-ethylhexanoate, zinc oleate, zinc phosphate, zinc benzoate;

metal salts such as:

salts of the metals tin, copper, zinc, and also chromates and dichromates, such as, for example, copper hydroxycarbonate, sodium dichromate, potassium dichromate, potassium chromate, copper sulphate, copper chloride, copper borate, zinc fluorosilicate, copper fluorosilicate;

oxides such as:

oxides of the metals tin, copper and zinc, such as, for example, tributyltin oxide, Cu₂O, CuO, ZnO;

oxidizing agents such as:

hydrogen peroxide, peracetic acid, potassium persulphate;

dithiocarbamates such as:

cufraneb, ferban, potassium N-hydroxymethyl-N′-methyl-dithiocarbamate, sodium dimethyldithiocarbamate, potassium dimethyldithiocarbamate, mancozeb, maneb, metarn, metiram, thiram, zineb, ziram;

nitriles such as:

2,4,5,6-tetrachloroisophthalonitrile, di sodium cyano-dithioimidocarbamate;

quinolines such as:

8-hydroxyquinoline and its copper salts;

other fungicides and bactericides such as:

bethozaxin, 5-hydroxy-2(5H)furanone, 4,5-benzodithiazolinone, 4,5-trimethylenedithiazolinone, N-(2-p-chlorobenzoylethyl)hexaminium chloride, 2-oxo-2-(4-hydroxyphenyl)acetohydroxycinnamoyl chloride, tris-N-(cyclohexyldiazeniumdioxy)aluminium, N-(cyclohexyldiazeniumdioxy)tributyltin or its potassium salts, bis-N-(cyclohexyldiazeniumdioxy)copper; iprovalicarb, fenhexamide, spiroxamine, carpropamid, diflumetorin, quinoxyfen, famoxadone, polyoxorim, acibenzolar S-methyl, furametpyr, thifluzamide, methalaxyl-M, benthiavalicarb, metrafenone, cyflufenamid, tiadinil, tea tree oil, phenoxyethanol,

Ag-, Zn- or Cu-containing zeolites alone or incorporated into polymeric materials.

Insecticides:

abamectin, acephate, acetamiprid, acetoprole, acrinathrin, alanycarb, aldicarb, aldoxycarb, aldrin, allethrin, alpha-cypermethrin, amidoflumet, amitraz, avermectin, azadirachtin, azinphos A, azinphos M, azocyclotin,

Bacillus thuringiensis, barthrin, 4-bromo-2(4-chlorophenyl)-1-(ethoxymethyl)-5-(trifluoro-methyl)-1H-pyrrole-3-carbonitrile, bendiocarb, benfuracarb, bensultap, betacyfluthrin, bifenthrin, bioresmethrin, bioallethrin, bistrifluoron, bromophos A, bromophos M, bufencarb, buprofezin, butathiophos, butocarboxim, butoxycarboxim,

cadusafos, carbaryl, carbofuran, carbophenothion, carbosulfan, cartap, chinomethionat, cloethocarb, 4-chloro-2-(2-chloro-2-methylpropyl)-5-[(6-iodo-3-pyridinyl)methoxy]-3(2H)-pyridazinone (CAS-RN: 120955-77-3), chlordane, chlorethoxyfos, chlorfenapyr, chlorfenvinphos, chlorfluazuron, chlormephos, N-[(6-chloro-3-pyridinyl)methyl]-N′-cyano-N-methylethanimidamide, chlorpicrin, chlorpyrifos A, chlorpyrifos M, cis-resmethrin, clocythrin, clothiazoben, cypophenothrin, clofentezin, cournaphos, cyanophos, cycloprothrin, cyfluthrin, cyhalothrin, cyhexatin, cypermethrin, cyromazin,

decamethrin, deltamethrin, demeton M, demeton S, demeton-5-methyl, diafenthiuron, dialiphos, diazinon, 1,2-dibenzoyl-1(1,1-dimethyl)hydrazine, DNOC, dichlofenthion, dichlorvos, dicliphos, dicrotophos, difethialone, diflubenzuron, dimethoate, 3,5-dimethylphenyl methylcarbamate, dimethyl(phenyl)silylmethyl-3-phenoxybenzyl ether, dimethyl(4-ethoxyphenypsilylmethyl-3-phenoxybenzyl ether, dimethylvinphos, dioxathion, disulfoton,

eflusilanate, emamectin, empenthrin, endosulfan, EPN, esfenvalerate, ethiofencarb, ethion, etofenprox, etrimphos, etoxazole, etobenzanid,

fenamiphos, fenazaquin, fenbutatin oxide, fenfluthrin, fenitrothion, fenobucarb, fenothiocarb, fenoxycarb, fenpropathrin, fenpyrad, fenpyroximate, fensulfothion, fenthion, fenvalerate, fipronil, flonicamid, fluacrypyrim, fluazuron, flucycloxuron, flucythrinate, flufenerim, flufenoxuron, flupyrazofos, flufenzine, flumethrin, flufenprox, fluvalinate, fonophos, formethanate, formothion, fosmethilan, fosthiazate, fubfenprox, furathiocarb

halofenocid, HCH (CAS RN: 58-89-9), heptenophos, hexaflumuron, hexythiazox, hydramethylnon, hydroprene,

imidacloprid, imiprothrin, indoxycarb, iodfenfos, iprinomectin, iprobenfos, isazophos, isoamidophos, isofenphos, isoprocarb, isoprothiolane, isoxathion, ivermectin, lama-cyhalothrin, lufenuron,

kadedrin,

lambda-cyhalothrin, lufenuron,

malathion, mecarbam, mervinphos, mesulfenphos, metaldehyde, methacrifos, methamidophos, methidathion, methiocarb, methomyl, metalcarb, milbemectin, monocrotophos, moxiectin,

naled, NI 125, nicotine, nitenpyram, noviflumuron,

omethoate, oxamyl, oxydemethon M, oxydeprofos,

parathion A, parathion M, penfluoron, permethrin, 2-(4-phenoxyphenoxy)-ethyl ethylcarbamate, phenthoate, phorate, phosalon, phosmet, phosphamidon, phoxim, pirimicarb, pirimiphos M, pirimiphos A, prallethrin, profenophos, promecarb, propaphos, propoxur, prothiophos, prothoate, pymetrozin, pyrachlophos, pyridaphenthion, pyresmethrin, pyrethrum, pyridaben, pyridalyl, pyrimidifen, pyriproxifen, pyrithiobac-sodium,

quinalphos,

resmethrin, rotenone,

salithion, sebufos, silafluofen, spinosad, spirodiclofen, spiromesifen, sulfotep, sulprofos,

tau-fluvaiinate, taroils, tebufenozide, tebufenpyrad, tebupirimphos, teflubenzuron, tefluthrin, temephos, terbam, terbufos, tetrachlorvinphos, tetramethrin, tetramethacarb, thiacloprid, thiafenox, thiamethoxam, thiapronil, thiodicarb, thiofanox, thiazophos, thiocyclam, thiomethon, thionazin, thuringiensin, tralomethrin, transfluthrin, triarathen, triazophos, triazamate, triazuron, trichlorfon, triflumuron, trimethacarb,

vamidothion, xylylcarb, zetamethrin;

herbicides and other algicides such as:

acetochlor, acifluorfen, aclonifen, acrolein, alachlor, alloxydim, ametryn, amidosulfuron, amitrole, ammonium sulphamate, anilofos, asulam, atrazine, azafenidin, aziptrotryne, azimsulfuron,

benazolin, benfluralin, benfuresate, bensulfuron, bensulphide, bentazone, benzofencap, benzthiazuron, bifenox, bispyribac, bispyribac-sodium, borax, bromacil, bromobutide, bromofenoxim, bromoxynil, butachlor, butamifos, butralin, butylate, bialaphos, benzoyl-prop, bromobutide, butroxydim,

carbetamide, carfentrazone-ethyl, carfenstrole, chlomethoxyfen, chloramben, chlorbromuron, chlorflurenol, chloridazon, chlorimuron, chlornitrofen, chloroacetic acid, chloransulam-methyl, cinidon-ethyl, chlorotoluron, chloroxuron, chlorpropham, chlorsulfuron, chlorthal, chlorthiamid, cinmethylin, cinofulsuron, clefoxydim, clethodim, clomazone, chlomeprop, clopyralid, cyanamide, cyanazine, cycloate, cycloxydim, chloroxynil, clodinafop-propargyl, cumyluron, clometoxyfen, cybutryn, cyhalofop, cyhalofop-butyl, clopyrasuluron, cyclosulfamuron,

diclosulam, dichlorprop, dichlorprop-P, diclofop, diethatyl, difenoxuron, difenzoquat, ditlufenican, diflufenzopyr, dimefuron, dimepiperate, dimethachlor, dimethipin, dinitramine, dinoseb, dinoseb acetate, dinoterb, diphenamid, dipropetryn, diquat, dithiopyr, diuron, DNOC, DSMA, 2,4-D, daimuron, dalapon, dazomet, 2,4-DB, desmedipham, desmetryn, dicamba, dichlobenil, dimethamid, dithiopyr, dimethametryn,

eglinazine, endothal, EPTC, esprocarb, ethalfluralin, ethidimuron, ethofumesate, ethobenzanid, ethoxyfen, ethametsulfuron, ethoxysulfuron,

fenoxaprop, fenoxaprop-P, fenuron, flamprop, flamprop-M, flazasulfuron, fluazifop, fluazifop-P, fuenachlor, fluchloralin, flufenacet, flumeturon, fluorocglycofen, fluoronitrofen, flupropanate, flurenol, fluridone, fluorochloridone, fluoroxypyr, fomesafen, fosamine, fosametine, flamprop-isopropyl, flamprop-isopropyl-L, flufenpyr, flumiclorac-pentyl, flumipropyn, flumioxzim, flurtamone, flumioxzim, flupyrsulfuron-methyl, fluthiacet-methyl,

glyphosate, glufosinate-ammonium,

haloxyfop, hexazinone,

imazarnethabenz, isoproturon, isoxaben, isoxapyrifop, imazapyr, imazaquin, imazethapyr, ioxynil, isopropalin, imazosulfuron, imazomox, isoxaflutole, imazapic,

ketospiradox,

lactofen, lenacil, linuron,

MCPA, MCPA-hydrazide, MCPA-thioethyl, MCPB, mecoprop, mecoprop-P, mefenacet, mefluidide, mesosulfuron, metam, metamifop, metamitron, metazachlor, methabenzthiazuron, methazole, methoroptryne, methyldymron, methyl isothiocyanate, metobromuron, metoxuron, metribuzin, metsulfuron, molinate, monalide, monalinuron, MSMA, metolachlor, metosulam, metobenzuron,

naproanilide, napropamide, naptalam, neburon, nicosulfuron, norflurazon, sodium chlorate,

oxadiazon, oxyfluorfen, oxysulfuron, orbencarb, oryzalin, oxadiargyl,

propyzamide, prosulphocarb, pyrazolate, pyrazolsulfuron, pyrazoxyfen, pyribenzoxim, pyributicarb, pyridate, paraquat, pebulate, pendimethalin, pentachlorophenol, pentoxazone, pentanochlor, petroleum oils, phenmedipham, picloram, piperophos, pretilachlor, primisulfuron, prodiamine, profoxydim, prometryn, propachlor, propanil, propaquizafob, propazine, propham, propisochlor, pyriminobac-methyl, pelargonic acid, pyrithiobac, pyraflufen-ethyl,

quinmerac, quinocloamine, quizalofop, quizalofop-P, quinchlorac,

rimsulfuron,

sethoxydim, sifuron, simazine, simetryn, sulfosulfuron, sulfometuron, sulfentrazone, sulcotrione, sulfosate,

tar oils, TCA, TCA-sodium, tebutam, tebuthiuron, terbacil, terbumeton, terbuthylazine, terbutryn, thiazafluoron, thifensulfuron, thiobencarb, thiocarbazil, tralkoxydim, tri-allate, triasulfuron, tribenuron, triclopyr, tridiphane, trietazine, trifluralin, tycor, thdiazimin, thiazopyr, triflusulfuron,

vernolate.

The invention furthermore relates to the use of the composition according to the invention for protecting industrial materials against attack and/or destruction by microorganisms.

Industrial materials in the present context are understood as meaning non-living materials which have been prepared for use in industry. Industrial materials which are to be protected by the present invention against microbial change or destruction are, for example, adhesives, sizes, paper and board, textiles, leather, wood, timber products, wood-plastic composites, paints, synthetic articles, cooling lubricants and other materials which can be attacked or destroyed by microorganisms. Parts of production plants, for example cooling-water circuits, which may be impaired by the proliferation of microorganisms may also be mentioned within the scope of the materials to be protected. Industrial materials in the context of the present invention are preferably adhesives, sizes, papers and boards, leather, wood, timber products, wood-plastic composites, paints, cooling lubricants and heat transfer liquids; particularly preferred industrial materials are wood, timber products and wood-plastic composites (WPC).

Wood is to be understood as meaning, in particular: construction timber, wooden beams, railway sleepers, bridge components, jetties, vehicles made of wood, boxes, pallets, containers, telephone poles, wooden fences, wood lagging, windows and doors made of wood, joiners work and wood-based materials used in domestic construction or carpentry and joinery.

Timber products are to be understood as meaning, in particular: plywood, chipboard, fibre board, oriented strand board (OSB) or composite board.

Wood-plastic composites are to be understood as meaning, in particular: thermoplastically processable composites consisting of wood, plastic and additives.

Wood is particularly preferred.

Microorganisms capable of degrading or changing the industrial materials which may be mentioned are, for example, bacteria, fungi, yeasts, algae and slime organisms. The compositions according to the invention preferably act against wood-destroying basidiomycetes, preferably holobasidiomycetes.

Here, mention may be made, in particular, of fungi of the following genera:

Coniophora, such as Coniophora puetana,

Lentinus, such as Lentinus tigrinus,

Polyporus, such as Polyporus versicolor,

Gloeophyllum, such as Gloeophyllum trabeum,

Poria, such as Poria placenta,

Corioius, such as Coriolus versicolor,

Stereum, such as Stereum sanguinolentum.

In addition, the compositions to be used according to the invention act against wood-destroying and soft rot-causing ascomycetes and associated deuteromycetes, such as, for example:

species of the genus Glenospora, such as Glenospora graphii,

species of the genus Chaetomium, such as Chaetomium globosum,

species of the genus Humicola, such as Humicola grisea,

species of the genus Petriella, such as Petriella setifera,

species of the genus Trichunis, such as Trichurus spiralis,

species of the genus Lecythophora, such as Lecythophora mutabilis

species of the genus Sclerophoma, such as Sclerophoma pityophila

species of the genus Aureobasidium, such as Aureobasidium pullulans.

The invention furthermore relates to industrial materials, in particular wood, a timber product or a wood/plastic composite, comprising

a) at least one azole and

b) at least one phenol of the formula (I) or a salt thereof

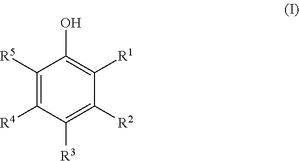

in which R¹, R², R³, R⁴ and R⁵ each independently of one another represent hydrogen, optionally substituted C₁-C₂₀-alkyl, C₂-C₂₀-alkenyl, C₇-C₁₈-alkylaryl or C₃-C₂₀-cycloalkyl, with the proviso that, if the radicals R¹-R⁵ exclusively represent optionally substituted C₁-C₂₀-alkyl or optionally hydrogen
at least one of the radicals R¹-R⁵ represents a C₁-C₂-alkyl radical substituted by a phenyl radical, where the phenyl radical is optionally substituted by hydroxyl and/or C₁-C₄-alkyl and
the compound of the formula (I) carries at least one methyl group, where the preferred embodiments mentioned above also apply here.

The invention furthermore relates to a process for protecting industrial materials against attack and/or destruction by microorganisms, characterized in that at least one composition comprising

a) at least one azole and

b) at least one phenol of the formula (I) or a salt thereof

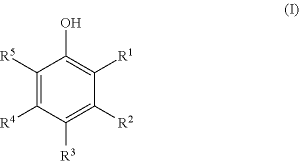

in which R¹, R², R³, R⁴ and R⁵ each independently of one another represent hydrogen, optionally substituted C₁-C₂₀-alkyl, C₂-C₂₀-alkenyl, C₇-C₁₈-alkylaryl or C₃-C₂₀-cycloalkyl, with the proviso that, if the radicals R¹-R⁵ exclusively represent optionally substituted C₁-C₂₀-alkyl or optionally hydrogen
at least one of the radicals R¹-R⁵ represents a C₁-C₂-alkyl radical substituted by a phenyl radical, where the phenyl radical is optionally substituted by hydroxyl and/or C₁-C₄-alkyl and
the compound of the formula (I) carries at least one methyl group

is allowed to act on the microorganism or its habitat, where the preferred embodiments mentioned above also apply here.

Surprisingly, it has now been found that the compositions according to the invention enhance the activity of azoles and are thus able to reduce weaknesses in activity, so that less active compound can be used or a broader spectrum of harmful fungi is covered. 6,6″-Di-tert-butyl-2,2′-methylenedi-p-cresol has a very low solubility in water of <1 ppm and a low vapour pressure (0.0001 hPa at 50° C.), which minimizes losses by leaching and/or evaporation. Compared to the activity enhancement with BHT described in U.S. Pat. No. 6,231,651, it is possible to use considerably smaller amounts of activity enhancer of component b), making the use more economical. In addition, in combination with azoles both styrenated phenol and 6,6′-di-tert-butyl-2,2′-methylenedi-p-cresol show synergism against various fungi.

In the process according to the invention or in the use according to the invention, the compositions are applied to the industrial material preferably by painting, drenching, spraying, impregnating or in a different manner.

For wood, industrial impregnation processes, for example the vacuum, double vacuum, vacuum-pressure or pressure process, are preferred.

Wood-plastic composites can be prepared, for example, by mixing with input of thermal energy, in particular extruding or injection moulding, wood particles, a thermoplastic polymer and the compositions.

Wood composites can be treated, for example, by the glue incorporation method. Here, the composition according to the invention is, if appropriate, added in the form of a formulation of the glue liquor and this biocidally finished glue is applied in a customary manner to the chips, in particular applied using a nozzle (for example in the case of chip boards or OSB boards) or applied via rolls to the veneer (for example in the case of plywood). In the surface process, the composition according to the invention is, if appropriate, sprayed in the form of a formulation to the timber product or applied using a roll.

The use concentrations of the active compounds according to the invention depend on the type and the occurrence of the microorganisms to be controlled, and on the composition of the material to be protected. The optimal rate can be determined by test series. In general, the use concentrations are in the range from 0.001 to 5% by weight, preferably from 0.005 to 1.0% by weight, of active compound plus activity enhancer and optionally other additives, based on the material to be protected.

In the industrial protection of wood, for example from 10 to 500 g of active compound are applied per m³ of wood, preferably from 50 to 300 g/m³ plus activity enhancer and optionally other additives.

### EXAMPLES

### Example 1

### Combinations of tebuconazole and 6,6′-di-tert-butyl-2,2′-methylenedi-p-cresol (Vulkanox® BKF) against the wood-destroying organism Coriolus versicolor

Mycelium pieces were punched out of a colony of the wood-destroying organism Coriolus versicolor and incubated on a malt extract/peptone-containing nutrient agar at 26° C. The growth of the hyphae with and without active compound and 6,6′-di-tert-butyl-2,2′-methylenedi-p-cresol was compared. The minimum inhibitory concentration (MIC) stated was the concentration at which the radial hyphae growth was suppressed completely (incubation time: about 1 week, independently of the fungal growth of the comparative sample without active compound).

The synergism was determined by the method described by Kull et al. (P. C. Kull, P. C. Eismann, H. D. Sylvestrowicz, R. L. Mayer, Applied Microbiology 1961, 9, 538-541). The following relationships apply:

$$\frac{{Q}_{A}}{{Q}_{a}} + \frac{{Q}_{B}}{{Q}_{b}} = SI$$

SI=1 means additivity

SI>1 means antagonism

SI<1 means synergism

Qₐ=concentration of substance A which is the MIC

Q_{b}=concentration of substance B which is the MIC

Q_{A}=concentration of substance A in the concentration of A/B at which microbial growth is suppressed

Q_{B}=concentration of substance B in the concentration of A/B at which microbial growth is suppressed

### Results:

| | MIC value against Coriolus | Synergistic |
|---|---|---|
| | versicolor (ppm) | value SI |
| tebuconazole | 1.0 | — |
| tebuconazole/phenol I²⁾ (1:4) | 2.0 | 0.45 |
| tebuconazole/phenol I²⁾ (1:9) | 3.0 | 0.39 |
| phenol I²⁾ | >30¹⁾ | — |

¹⁾no intrinsic activity could be detected at up to 30 ppm.
²⁾phenol I: 6,6′-di-tert-butyl-2,2′-methylenedi-p-cresol (Vulkanox ® BKF, 98%)

In the case of the wood-destroying organism Coriolus versicolor, tebuconazole and 6,6′-di-tert-butyl-2,2′-methylenedi-p-cresol show a pronounced synergism at various mixing ratios.

### Example 2

### Combinations of Tebuconazole and Styrenated Phenol (Vulkanox® SP) Against the Wood-Destroying Organism Coriolus versicolor

| | MIC value against Coriolus | Synergistic |
|---|---|---|
| | versicolor (ppm) | value SI |
| tebuconazole | 1.0 | — |
| tebuconazole/phenol II²⁾ (1:1) | 0.5 | 0.26 |
| tebuconazole/phenol II²⁾ (1:4) | 2.0 | 0.45 |
| tebuconazole/phenol II²⁾ (1:9) | 2.0 | 0.26 |
| phenol II²⁾ | >30¹⁾ | — |

¹⁾no intrinsic activity could be detected at up to 30 ppm.
²⁾phenol II: styrenated phenol (Vulkanox ® SP): about 12% monostyrenated, about 45% distyrenated and about 43% tristyrenated

In the case of the wood-destroying organism Coriolus versicolor, tebuconazole and styrenated phenol show a pronounced synergism.

### Example 3

### Combinations of Tebuconazole and Styrenated Phenol (Vulkanox® SP) Against the Wood-Destroying Organism Lentinus tigrinus

| | MIC value against Lentinus | Synergistic |
|---|---|---|
| | tigrinus (ppm) | value SI |
| tebuconazole | 0.3 | — |
| tebuconazole/phenol II²⁾ (1:1) | 0.5 | 0.84 |
| phenol II²⁾ | >30¹⁾ | — |

¹⁾no intrinsic activity could be detected at up to 30 ppm.
²⁾II styrenated phenol (Vulkanox ® SP): about 12% monostyrenated, about 45% distyrenated and about 43% tristyrenated

In the case of the wood-destroying organism Lentinus tigrinus, tebuconazole and styrenated phenol show a pronounced synergism.

What is claimed is:

1. A process for protecting industrial materials against attack and/or destruction by microorganisms, comprising:
contacting said industrial materials with a composition comprising
a) at first azole and
b) at least one phenol of the formula (I) or a salt thereof 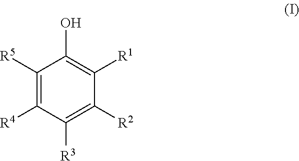
wherein R¹, R², R³, R⁴ and R⁵ each independently of one another represent hydrogen, optionally substituted C₁-C₂₀-alkyl, C₂-C₂₀-alkenyl, C₇-C₁₈-alkylaryl or C₃-C₂₀-cycloalkyl, with the proviso that, if the radicals R¹-R⁵ exclusively represent optionally substituted C₁-C₂₀-alkyl or optionally hydrogen
at least one of the radicals R¹-R⁵ represents a C₁-C₂-alkyl radical substituted by a phenyl radical, where the phenyl radical is optionally substituted by hydroxyl and/or C₁-C₄-alkyl and
wherein the compound of the formula (I) carries at least one methyl group.

2. The process according to claim 1, wherein said first azole is a triazole.

3. The process according to claim 1, wherein said first azole is selected from the group consisting of azaconazole, bitertanol, bromuconazole, cyproconazole, diclobutrazol, difenoconazole, diniconazole, epoxyconazole, etaconazole, fenbuconazole, fluquinconazole, flusilazole, flutriafol, furconazole, hexaconazole, imibenconazole, ipconazole, myclobutanil, metconazole, penconazole, propiconazole, prothioconazole, simeconazole, tebuconazole, tetraconazole, triticonazole and uniconazole and their metal salts and acid adducts, and wherein said composition further comprises a second azole selected from the group consisting of triadimenol and triadimefon.

4. The process according to claim 1, wherein said first azole is selected from the group consisting of tebuconazole, propiconazole and cyproconazole.

5. The process according to claim 1, wherein said first azole is selected from the group consisting of tebuconazole, propiconazole and cyproconazole and wherein said composition further comprises a second azole selected from the group consisting of triadimenol and triadimefon.

6. The process according to claim 1, wherein at least one of the radicals R¹-R⁵ of the formula (I) represents
—CHR⁶-phenyl in which
R⁶ represents hydrogen or methyl and
phenyl is unsubstituted or substituted by hydroxyl and at least one C₁-C₄-alkyl radical.

7. The process according to claim 1, wherein said at least one phenol of the formula (I) is at least one styrenated phenol or 6,6′-di-tert-butyl-2,2′-methylenedi-p-cresol.

8. The process according to claim 1, wherein said industrial material is wood, a timber product or a wood-plastic composite.

9. The process according to claim 1, wherein said microorganisms are selected from the group consisting of basidiomycetes, holobasidiomycetes and mixtures thereof.
